(19) United States
(12) Patent Application Publication
(10) Pub. No.: US 2009/0276695 A1
(43) Pub. Date: Nov. 5, 2009

(54) AUTOMATIC DOCUMENT GENERATOR

(75) Inventors: Christopher Hodges, Hertfordshire (GB); Leigh Warren, Buckinghamshire (GB)

Correspondence Address: KLARQUIST SPARKMAN, LLP, 121 SW SALMON STREET, SUITE 1600, PORTLAND, OR, 97204, US

(73) Assignee: Wave2 Media Solutions Ltd.

(21) Appl. No.: 12/434,562

(22) Filed: May 1, 2009

Related U.S. Application Data
(60) Provisional application No. 61/052,599, filed on May 12, 2008.

(30) Foreign Application Priority Data
May 2, 2008 (GB) 0808109.3

(51) Int. Cl. G06F 17/00

(52) U.S. Cl. 715/249

(57) ABSTRACT

A document template generator is provided for creating a document template, a pair of templates (200, 300) is provided with corresponding objects. A processing module (22) compares a parameter of input data to a parameter of a dominant object in one of the paired templates (200, 300) to calculate a transformation value therebetween. A template creation module (26) transforms objects in one template (200) towards the form of objects in the second template (300) by a factor equal to the calculated transformation value.

This invention relates to the field of document generation and, in particular, the automatic generation of documents from a set of input data.

Any document that comprises more than one group of data requires some kind of organisation to control how the data are displayed in the document. For example, the page of a newspaper may comprise a title, a main article, a subsidiary article, a photograph, a caption, adverts, and graphics such as logos and lines separating columns of text. These discreet groups of information are typically presented on a page in a logical order which is designed to be aesthetically pleasing. Historically the task of organising groups of data in newspapers has been undertaken by administrative editors who manually organise the data based on their experience.

In order to reduce the burden of generating a document, templates can be used. Typically templates comprise a base area (which may correspond to the area of a printed page), and several windows which define areas for different groups of data. Thus, the template may be a tiled array of windows for a potentially large number of different types of data. The windows in a template may be arranged in locations chosen by a template designer to create a particular effect. One well known example is provided by software which offers templates for greetings cards, brochures, business cards, invitation cards, advertisements, and so on. The template may comprise text windows, image windows, graphics such as borders and logos, and other types of windows including video windows, should the document have video viewing capabilities. The windows in the template may be blank so that a user of the template can input their own data, or else default data may be input to the windows as a starting point for a user. A user may be presented with a list of different possible templates and the user may use their judgement to select the template that will best suit their purpose.

While templates are provided to improve efficiency in document generation, they present several problems. Firstly, the selection of a template may be a time consuming exercise, and a user may inadvertently choose an inappropriate template that will not fit their input data. Secondly, as templates typically comprise fixed-size windows, it is common that the input data do not fit well inside the template windows.

According an aspect of the present invention there is provided a template selector comprising: a data receiving module for receiving input data which are intended for display in a document; a template storage unit for storing data relating to a plurality of document templates; and a template selection tool for selecting an appropriate template from the template storage unit by comparing at least one attribute of the input data to at least one attribute of each of the stored templates.

In this way the template that best fits the input data may be selected and used as the basis for building a document.

The criteria for determining which template is most appropriate, and which template best fits the input data, may be dependent on the circumstances. For example, the input data may comprise text and an image which may be suitable for being input respectively to a text object and an image object on a template. The appropriate template may have a text object that most closely matches the input text, or an image object that most closely matches the input image, or the appropriate template may have text and image objects that provide the closest aggregate match to the input data. The settings for determining the appropriate template are preferably user configurable.

In order to select the appropriate template it is preferable to compare more than one attribute of the input data to attributes of the templates. This may be advantageous because a number of different types of data may be input and a template may comprise a number of different objects.

Preferably the selected template has associated rules regarding the input data that may be received and displayed therein. The rules may control the properties of the data that can be received and displayed in the template. In one non-limiting example, the templates may each comprise a tag indicating their purpose. In the field of newspapers, templates may be tagged as: front page, back page, odd page, even page, central page, and so on. The input data for a given page may also be tagged to indicate which page they are intended for. Thus, a front page template may be arranged only to accept input data with a matching tag.

Preferably each template comprises at least one object for receiving data for display. The objects may be defined areas for displaying data. In this way, the template may be tiled with a plurality of objects that each display input data. The template may include a plurality of discreet objects that are arranged on the template by a template designer.

Each object may have associated data acceptance rules regarding the input data that may be received and displayed in the object. There may be several different types of input data. For example, input data may be main body text, caption text, an image, a graphic such as a logo, a video, and so on. Preferably the data acceptance rules associated with an object specify a particular type (or types) of input data that may be received and displayed in the object.

Each object may be designed by a template designer. An object may take any shape, including non-rectangular shapes, and it may have curved sides.

Most preferably the associated data acceptance rules of the object specify a property, or a range of properties, that the input data must possess to be received and displayed in the object. For example, if the input data is text the number of characters of the input text may be constrained by data acceptance rules to be above or below a predetermined threshold or within a predetermined range, if the text is to be received and displayed in an object. By applying data acceptance rules such as these it may be possible to ensure that the input data can be properly received in the object.

In the example above, a text object may support a maximum number of characters in a particular font and point size. In addition, it may be desirable that the object is not under-filled by text by more than a predetermined percentage; this may be desirable for aesthetic reasons to ensure that “white space” is minimised in any generated document. In these circumstances the data acceptance rules may specify that input text is only accepted if the number of characters falls within a specified range.

Similar data acceptance rules may limit the properties of other types of input data that can be received and displayed in an object. For an image object, for example, it may be desirable that the associated data acceptance rules specify that the input image has a specified area, shape, number of pixels, or image file size.

Each object may have an associated style which defines a predetermined set of data acceptance rules. Thus, by defining a style a list of data acceptance rules may be applied automatically to an object. It may be quicker and easier to define a style for an object than defining each of a potentially large set of data acceptance rules.

Styles may be used by an administrator who creates the templates in the template storage unit. The administrator may select a style that is most appropriate for a given object in the circumstances. For example, two different styles might specify different ranges of properties that the input data must possess to be received and displayed in an object. One style may specify a narrow range of properties for the input data, whereas another style may specify a broad range of properties.

Preferably there are a predetermined number of styles that can be selected for a specific object.

The template itself may have a style which automatically defines each rule for each object therein. Thus, an administrator may be able to create templates quickly without even ascribing a style to individual objects.

Each template may comprise a dominant object, and the template selection tool may be arranged to select an appropriate template by comparing at least one attribute of the input data to at least one attribute of the dominant object in each of a plurality of templates stored in the template storage unit. In this way, the attributes of the dominant object may be most relevant in selecting the appropriate template. Preferably the dominant object is a text object and thus the text object may be used primarily in selecting the appropriate template. This may be advantageous because the text in a document may be the most relevant portion and thus, a document may be built around the dominant object and the text therein.

Of course, in alternative embodiments a different type of object, such as an image object, may be dominant. Also, while the dominant object is used to select the appropriate template it may also be advantageous to use the attributes of other objects in the selection process.

Where the dominant object is a text object the template may be considered to be “editorially led”, in the sense that it is defined by the text data therein. Where the highest priority objects are intended for advertisement data the template may be considered to be “promotionally led”.

The template selection tool may be arranged to assign a score to a template in the template storage unit. The score may be determined according to the closeness of comparison of at least one attribute of the template to at least one attribute of the input data. By scoring templates in this way it may be possible to select the most appropriate template by selecting the template having the highest score (of course, the ‘best’ score could also be the lowest numerical score depending on the system set up). Preferably a template scores highly for each attribute of the template that closely matches a corresponding attribute of the input data.

Scoring may be relative such that the closer the match between the input data attribute and the template attribute, the higher the score. The scoring may also be binary to indicate an acceptable match (pass) or an unacceptable match (fail). In some embodiments a combination of binary and relative scoring may be used.

A weighting may be applied to the score for the comparison of an individual attribute. In this way, attributes may have a different relative importance in terms of the overall score for a template.

A template may also receive a score for reasons independent of the input data. For example, particular templates may be designated as preferred templates. These templates may receive a score in order to improve their likelihood of selection as the appropriate template.

The template selection tool may assign a score iteratively according to the closeness of comparison of a n^{th} attribute of the template to a n^{th} attribute of the input data. This may be useful in shortening the scoring procedure and the associated processing time. Where binary “fail” scores are applied to inappropriate templates this iterative scoring process may continue until there is only one template remaining in the template storage unit that does not possess a “fail” score. By default this template may then be selected as the appropriate template.

Preferably an attribute of the dominant object in a template is compared with a corresponding attribute of the input data as the first step in the iterative scoring procedure. The templates may be scored according to attributes of the dominant objects in the templates. A secondary scoring procedure may be undertaken to find the best match between the input data and the remaining objects in the templates.

Preferably the templates are scored using meta-data. In this way, the template scoring may be considered to be predictive scoring since it is not necessary for documents to be generated in order for a template to receive a score.

The document generator may comprise a sorting module which is arranged to sort templates in the template storage unit based on their score. Thus, the first template in an ordered list may be selected as the appropriate template.

The document generator may also comprise a filtering module which is arranged to filter templates in the template storage unit in order to exclude inappropriate templates. The filtering may be achieved by comparing at least one attribute of the input data to at least one attribute of each of a plurality of templates stored in the template storage unit. In this way, if a particular template is incompatible with the input data it can be excluded from further consideration. This can be advantageous in shortening processing time if there are a large number of templates stored in the template storage unit.

One way that filtering may be achieved in practice is by assigning a binary “fail” score to an inappropriate template.

Preferably templates are stored in the template storage unit as meta-data. The meta-data may comprise information about the templates such as the number of objects therein and data relating to the objects such as their area and associated data acceptance rules. Thus, the data capacity of the template storage unit may be minimised. Also, the computational burden of searching through the template storage unit may be minimised. By using meta-data, it is an abstraction of a real template that may be used in the template selection process.

According to another aspect of the present invention there may be provided a document generator comprising: the template selector as previously described and a document building module for building a document by fitting the input data to the selected template.

The document building module may be arranged to format the input data to fit in the selected template. In this way data can be modified, if necessary, to fit in objects on the selected template. This may be necessary where there is a disparity in the size of the input data and the object that the data are intended to be displayed in. Preferably the data are formatted in order to substantially fill the object in the template. Thus, the white space in the generated document may be minimised. Text data may be formatted by utilising text effects such as point size, leading (increasing the vertical space between lines), letter spacing, stretching letters, and modifying the point size of a character relative to a percentage of the original size of the letter.

The data may have some form of default formatting before they are formatted by the document building module. Thus, the document building module may be arranged to re-format the input data.

Preferably the document building module determines whether the input data would fill an object in the template. In the event that the input data would exactly fill the intended object then it may be desirable that the data are not formatted. Similarly, if the input data would under-fill the object by less than a predetermined percentage it may be preferable to leave the data unformatted. If the input data would over-fill the object or if the input data would under-fill the object by more than a predetermined percentage it may be desirable that the input data are formatted.

The document building module may determine whether the input data would over-fill or under-fill an object in the template. Where the input data is text the number of characters may be greater or less than the maximum number of characters that an object in the template is arranged to receive (at a default font and point size). In the art, these two situations are described respectively as “overset” data and “underset” data. Where the data are overset it may be necessary to format the data to reduce its size so that it can fit into the intended object. Where the data are underset it may be desirable to format the text to increase its size in order that the intended object is completely filled, leaving a minimum of white space. Text data may be best formatted by modifying the font and/or point size or other typographical attributes.

Types of data other than text may be formatted in a wide variety of ways. For example, an image may be formatted in any combination of at least the following ways: reduce size, stretch vertically, stretch horizontally, crop, crop to change shape.

The template may comprise at least one object for receiving and displaying input data, and the building step may involve formatting the input data according to building rules associated with each object. The building rules may be arranged to format input data so that they fill an object in a user defined way. For example, building rules may specify that an overset image is formatted to be reduced/expanded such that its horizontal dimensions match that of the template. The building rules may further specify that the image is cropped along its lower edge, if necessary to completely fill the object.

The building rules may be specific to each object and may be user configurable, as different building rules may be appropriate in different circumstances. Each object may have associated data acceptance rules regarding the input data that may be received and displayed in the object, and the building rules associated with an object may be linked to the data acceptance rules.

While the building rules may be quite different in purpose to the data acceptance rules the two may be linked so that the building rules are automatically determined once the data acceptance rules are set (and vice-versa). Typically building rules may be set by an administrator who creates the templates in the template storage unit. By linking the building rules to the data acceptance rules the time taken to create a template may be reduced.

Alternatively, or in addition, the building rules may be determined by the style of the object, or the style of the template.

The document building module may be arranged to fit pre-stored data to an object in a template. Thus, the generated document may comprise a combination of input data and pre-stored data. The pre-stored data may be standard images, texts or logos that are appropriate to combine with the input data.

The appropriate template may comprise more objects than can be filled by the input data. For example, the appropriate template may comprise two image objects whereas the input data may only comprise one image file. By filling the unfilled object with pre-stored data the area of white space in a generated document may be minimised.

The pre-stored data may require formatting, as previously described, if it does not precisely fill the object in question.

The building rules may specify that pre-stored data are fitted in an object, alone or in combination with input data. Thus, where input data are underset it may be possible to fill the object in question by combining the input data with pre-stored data. For example, where the input text would leave white space at the bottom of a text object, this space may be filled by pre-stored filler text or by a pre-stored filler image.

According to another aspect of the present invention there is provided a document template generator for creating a document template comprising: a base template having a primary object for receiving data for display; a data receiving module for receiving input data which are related to data for display in a template; a processing module for comparing a parameter of the input data to a parameter of the primary object in the base template to determine a transformation value therebetween; and a template creation module for creating a template by transforming objects in the base template, wherein the primary object is transformed by the transformation value.

In this way, a template may be created that has been tailored to match input data. In one example, the primary object in the base template may be a text box for receiving text for display. The input data may be the number of characters of text that is proposed to be displayed in a template. By comparing the number of characters that is proposed to be input with the capacity number of characters of the text box a transformation value can be determined. The primary object may then be transformed in size by the transformation value so that the object in the created template can accommodate the proposed text. Other objects in the base template may be similarly modified according to the change in size of the primary object.

Thus, problems arising from having a limited number of templates are resolved. By this method a very large number of templates are possible because the templates are created according to the data that are proposed for display in the template.

While the above example describes an embodiment where the primary object is a text box, many different types of primary object are possible. For example, the primary object may be a picture box for receiving an image for display or a video window for displaying a video feed.

Once a template has been created, the template may be used for generating a document. This may be achieved by manually inputting data to the template or by automatically building a document using building rules, as previously described.

The base template is preferably stored in the template storage module.

Preferably the primary object has a first predetermined form and a second predetermined form and the template creation module is preferably arranged to transform the primary object in the base template from its first form towards its second form.

Thus, the primary object may take any form that is intermediate between the first form and the second form. This may be desirable where the input data would fit an object whose form is intermediate between the first and second forms of the primary object. The first and second forms may differ in all parameters including area, shape, position in the base template, colour, and so on. Thus, a large number of intermediate forms are possible when the primary object is transformed form its first form towards its second form.

Preferably the primary object is only transformed where the parameter of the input data is intermediate between the respective parameters of the primary object in its first and second forms.

The base template may have a plurality of objects each having corresponding first and second predetermined forms, and the template creation module may be arranged to transform all objects relatively from their first form towards their second form. In this way, each object in the base template may be transformed so that a new template can be created.

The transformation value for each transformation may be proportional to the closeness of fit of one parameter of the input data relative to the primary object. Thus, the primary object may be a dominant object in the sense that it defines the transformations for all other objects in the template.

An object may have an identical first and second form. In these circumstances there is no relative change between the first form and the second form. Therefore, the object may be unchanged by a transformation even if the primary object was changed by a large factor.

In one example, the primary object may be smaller in its first form than its second form. Another object in the template may be larger in its first form than its second form. In these circumstances the primary object would become larger when it was transformed from its first form towards its second form, whereas the other object would become smaller.

The transformation value may relate to the relative transformation that is required to transform the primary object from its first form towards its second form, and all objects may be transformed from the first form towards the second form by a factor equal to the transformation value.

All objects may be transformed by different amounts in an absolute sense. Also, all objects may be transformed by different amounts relative to their first form. By transforming objects by the transformation value all objects in the template may be mapped to a form which is a fixed intermediate between the first and second forms. The transformation value may be expressed conveniently as a percentage.

Preferably objects in the template are arranged such that they do not overlap or otherwise interfere with one another when they assume forms intermediate between their first and second forms. In this way the created templates may be usable for generating documents by displaying discrete data distinctly, where this is desirable.

The base template may be a paired template comprising a first template having a primary object in a first form and a second template having a corresponding primary object in a second form. Also, the template creation module may be arranged to transform all objects in the first template towards the form of the corresponding objects in the second template.

In this way, a paired template may be used as the base for creating a new template. The pair of templates may comprise a plurality of corresponding objects and the created template may comprise objects that are intermediate between objects on the first template and objects on the second template.

The transformation value may be the degree to which objects are altered from their first form towards their second form. As mentioned, the transformation value preferably depends on the factor by which primary object needs to be transformed from its first form towards its second form in order to match a parameter of input data. The transformation value may be best expressed as a percentage between 0% and 100%, where 0% indicates that no transformation is required from the first form and 100% indicates that a full transformation from the first form to the second form is required.

The paired template approach may provide a useful visual tool for anticipating the possible templates that may be created. A user may be able to examine the first template and the second template and anticipate those templates with forms that are intermediate between the two.

The primary object may be a text box and the input data may be related to text for display in the template. In this way, a template may be created around a body of text. For written publications (such as newspapers) this may be the preferred set up as text tends to be the most relevant data to be displayed. However, alternative publications may necessitate different primary objects such as image or video boxes.

The input data is preferably text, but as an alternative the input data may be meta-data about the text. For example, meta-data may comprise information about the text length, font, colour and subject matter. Information about the text may be compared with a property of the text box for determining a transformation value. Preferably the number of characters of text is compared with the maximum number of characters that fit in the text box.

The template creation module may be arranged to transform all objects in the base template according to transformation rules. The transformation rules may be user configurable in order to achieve fine control over the created document.

Preferably the transformation rules specify that objects are transformed from their first form towards their second form by the transformation value. However, other rules may apply in specific circumstances. For example, where objects transformed by the transformation value would overlap in the created template, the transformation rules may adjust the transformation of one or both of the objects to avoid an overlap.

The transformation rules may control the relative forms of objects in the created template. Thus, the relative sizes, shapes and positions of objects in the created template may be controlled. Most preferably this is done in order to avoid objects undesirably overlapping. In particular, the transformation rules may specify that the separation of specified objects in the created template is fixed at, above, or below a predetermined value.

Of course, in some circumstances it may be desirable that objects overlap. For example, one object may be text and another may be for a background colour or graphic. It may be desirable to overlay these objects in a template for aesthetic reasons.

According to another aspect of the present invention there is provided a template selector comprising: a data receiving module for receiving input data which are intended for display in a document; a template storage unit for storing data relating to a plurality of document templates; a template selection tool for selecting an appropriate base template from the template storage unit by comparing at least one attribute of the input data to at least one attribute of each of the stored templates, the appropriate base template having a primary object for receiving data for display; a processing module for comparing a parameter of the input data to a parameter of the primary object in the base template to determine a transformation value therebetween; and a template creation module for creating a template by transforming objects in the base template, wherein the primary object is transformed by the transformation value.

Preferably a document generator is provided that comprises the template selector defined above and a document building module for building a document by fitting the input data to the created template. In this way, a template can be created and a document generated based only on input data that are intended for display in a document. The created template can be built from a base which is most suited to the input data and from there it may be tailored to best match the specific parameters of the input data.

According to yet another aspect of the present invention there is provided a method of selecting a template comprising the steps of: receiving input data at a document generator, which data are intended for display in a document; and selecting an appropriate template from a template storage unit, wherein the selection step is undertaken by the document generator and involves comparing at least one attribute of the input data to at least one attribute of each of a plurality of templates stored in the template storage unit.

According to yet another aspect of the present invention there is provided a method of creating a document template comprising the steps of: providing a base template having a primary object for receiving data for display; receiving input data related to data for display in a template; comparing a parameter of the input data to a parameter of the primary object in the base template to determine a transformation value therebetween; and creating a template by transforming all objects in the base template, wherein the primary object is transformed by the transformation value.

According to yet another aspect of the present invention there is provided a computer readable storage medium having stored thereon a computer program, the computer program comprising: a program module which receives input data, which data are intended for display in a document; and a program module which selects an appropriate template from a template storage unit by comparing at least one attribute of the input data to at least one attribute of each of a plurality of templates stored in the template storage unit.

According to yet another aspect of the present invention there is provided a computer readable storage medium having stored thereon a computer program, the computer program comprising: a program module which provides a base template having a primary object for receiving data for display; a program module which receives input data related to data for display in a template; a program module which compares a parameter of the input data to a parameter of the primary object in the base template to determine a transformation value therebetween; and a program module which creates a template by transforming all objects in the base template, wherein the primary object is transformed by the transformation value.

Any method features described herein may be provided as apparatus features and vice-versa.

Preferred features of the present invention will now be described, purely by way of example, with reference to the accompanying drawings, in which:

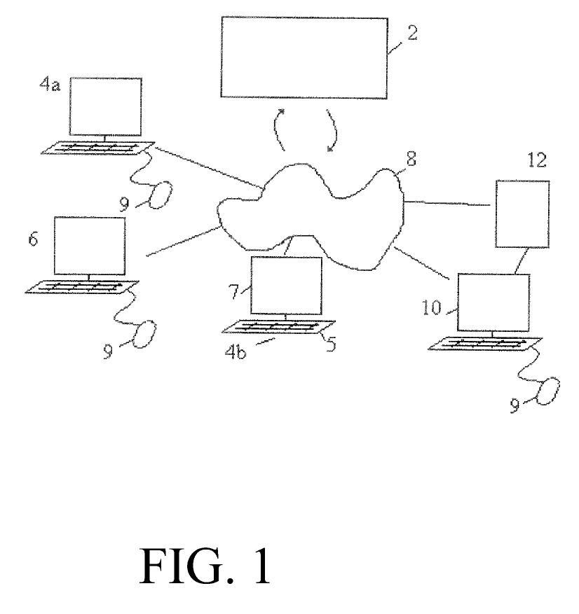

FIG. 1 shows a general overview of an automatic document generator in an embodiment of the invention;

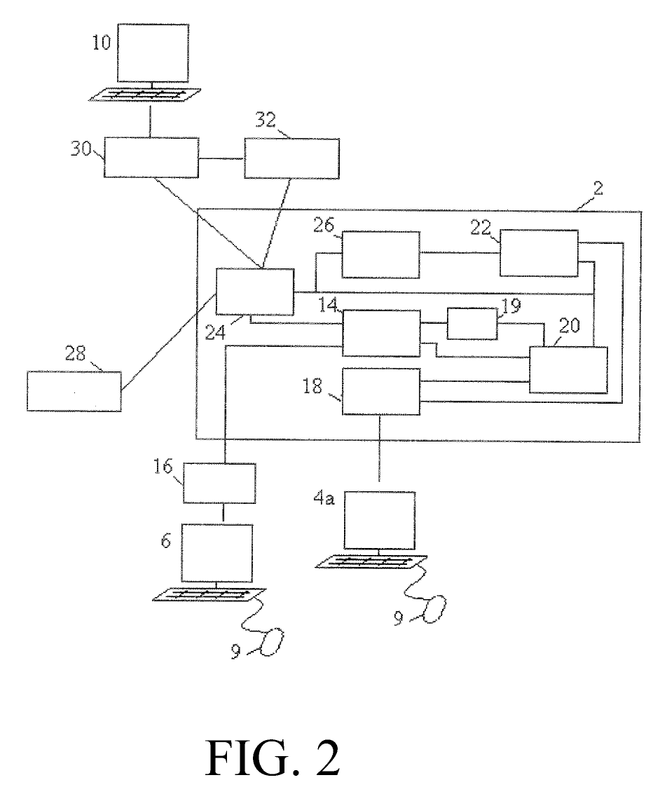

FIG. 2 shows the structure of an automatic document generator in an embodiment of the invention;

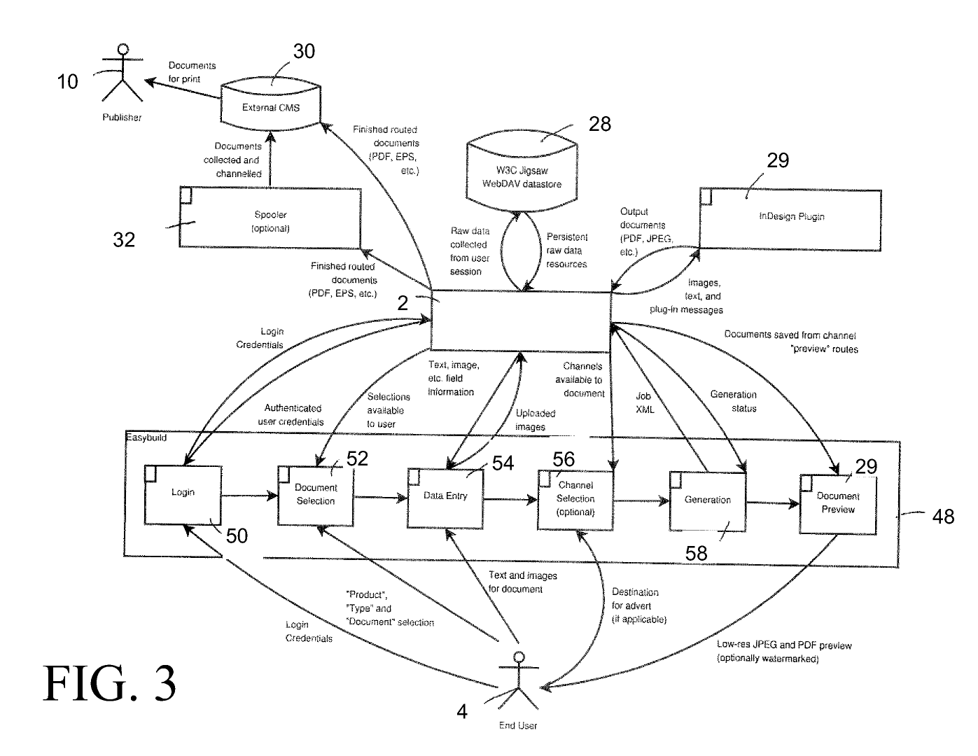

FIG. 3 shows an automatic document generator interfacing with other components as well as a flow diagram demonstrating how a user can interface with the automatic document generator;

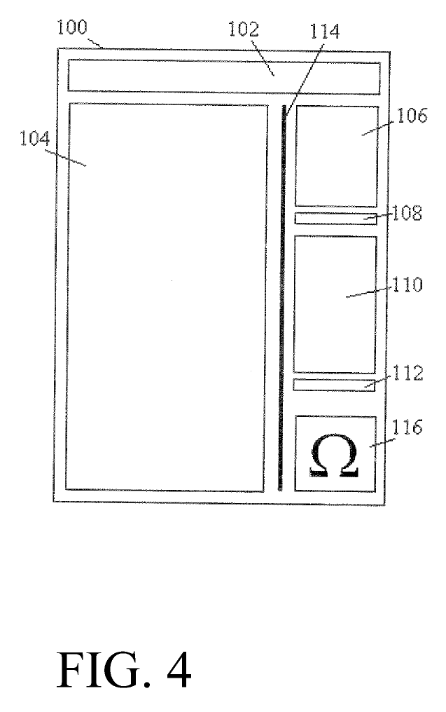

FIG. 4 shows an example of a document template that may be stored in the automatic document generator of the invention;

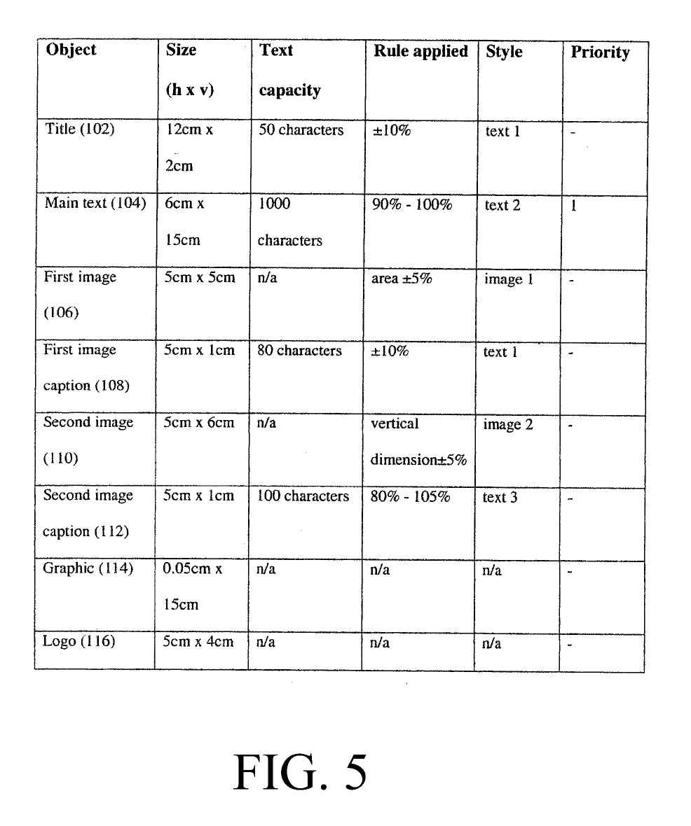

FIG. 5 is a table detailing the properties of the document template of FIG. 4;

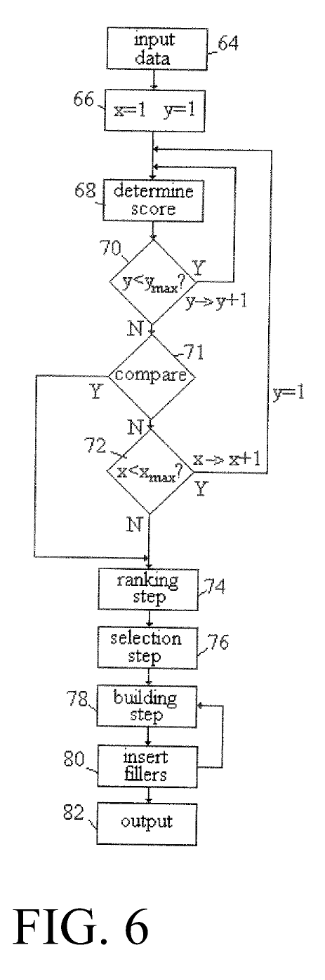

FIG. 6 is a flow diagram demonstrating the operations of an automatic document generator in an embodiment of the invention;

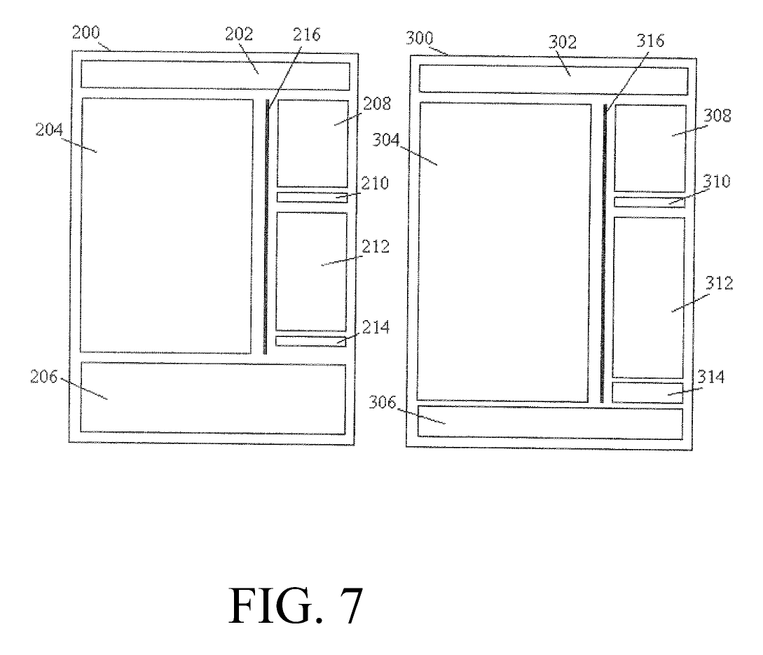

FIG. 7 shows an example of a pair of document templates that may be stored in the automatic document generator of the invention;

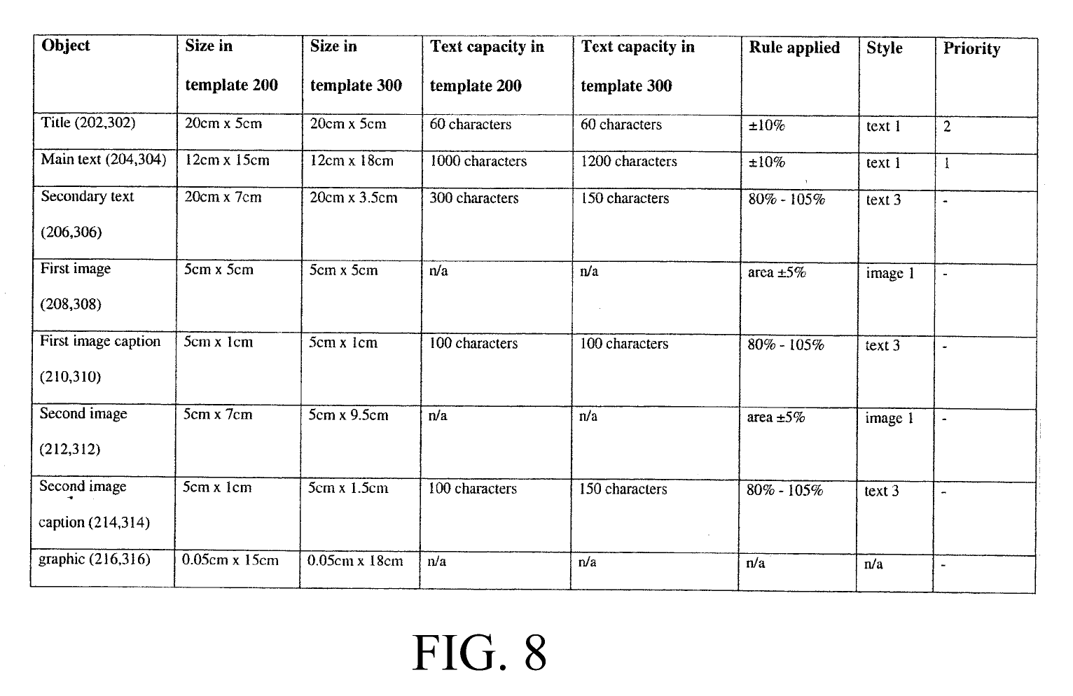

FIG. 8 is a table detailing the individual properties of the pair of document templates of FIG. 7;

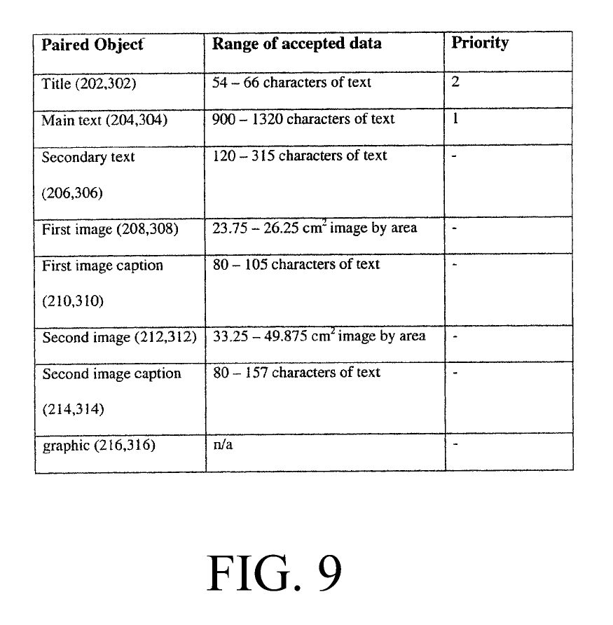

FIG. 9 is a table detailing the properties of the pair of document templates of FIG. 7 when they are linked as a paired template;

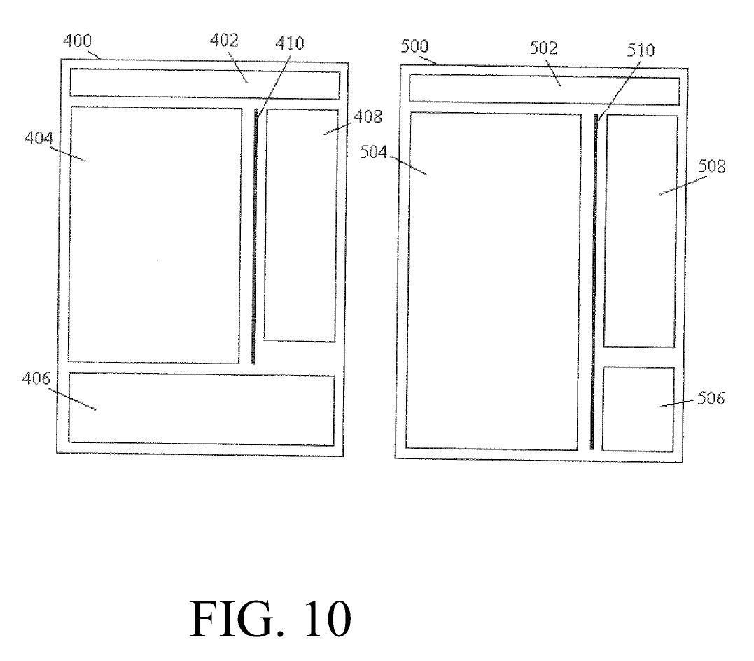

FIG. 10 shows another example of a paired document template that may be stored in the automatic document generator of the invention;

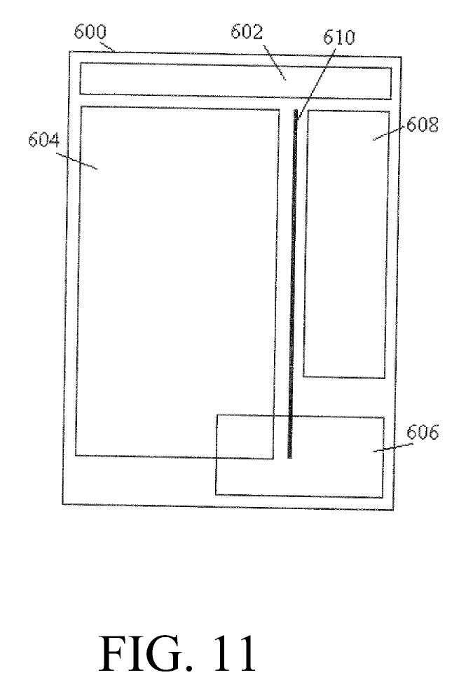

FIG. 11 shows a first example of a template that may be created from the paired document template of FIG. 10; and

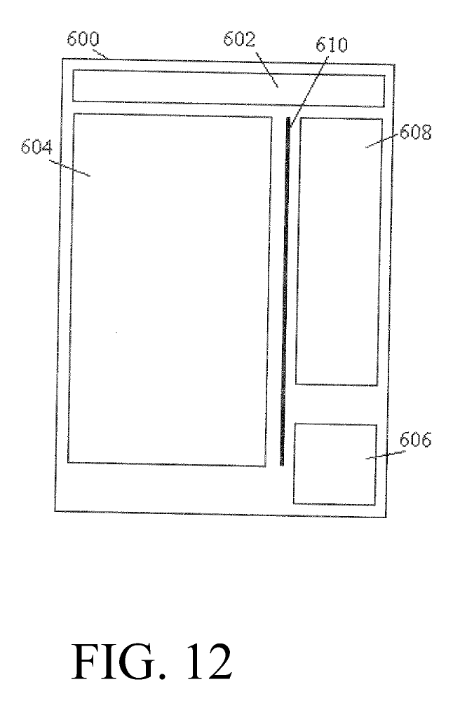

FIG. 12 shows a second example of a template that may be created from the paired document template of FIG. 10.

### DETAILED DESCRIPTION OF EMBODIMENTS OF THE INVENTION

FIG. 1 shows a general overview of the automatic document generator 2 of the invention interfacing with terminal computers over the internet 8. Users connect to the automatic document generator 2 via user terminal computers 4a, 4b in order to submit requests for documents to be generated, upload relevant data, and download generated documents. The terminal computers may have a display 7, a keyboard 5 and a pointer device 9 such as a mouse.

An administrator may connect to the automatic document generator 2 via an administrator terminal computer 6 in order to set the operational parameters of the automatic document generator 2. Finally, a publisher may connect to the automatic document generator 2 with a publisher terminal computer 10. The publisher may receive data from the automatic document generator which is intended to be published, and the publisher has a printer device 12 for printing documents. The printer device 12 can print hard copies of documents and also publish electronic copies of documents on the internet 8 or to computer readable storage media.

The automatic document generator 2 may be a server computer which is accessible via the internet. The automatic document generator 2 may also be implemented as a processor running the appropriate software modules.

A better understanding of the present invention may be achieved with reference to FIG. 2 which shows further details of the automatic document generator 2 in an embodiment of the invention.

The automatic document generator 2 comprises a template storage unit 14 which is arranged to store details of a plurality of templates which may be used in the generation of documents. Data are uploaded to the template storage unit 14 by an administrator 6 who can communicate with the automatic document generator 2 via a configuration tool 16. Document templates are stored in the template storage unit 14 as meta-data. Thus, templates that are intended to be stored in the template storage unit 14 are scanned and converted into meta-data. This process can be undertaken at the administrator terminal computer 6 or at the automatic document generator 2. By storing templates in this way the number of bytes required to store an individual template can be minimised.

The template storage unit 14 may store individual page templates, pre-built template such as paired templates, or multi-page templates. A multi-page template is a template for a document such as a newspaper which may comprise a large number of pages. Typically a multi-page document template is a partially generated document. Thus, the multi-page template may comprise data such as articles that are already built into the document, and may also comprise spaces for new data such as advertisements which are to be populated by the automatic document generator. Pages that are already fully generated and do not have space for new data are known as static pages, and pages that have space for new data are known as dynamic pages.

The automatic document generator 2 also comprises a data receiving module 18 which is arranged to receive data from a user 4. Typically, a user will upload data to the data receiving module 18, which data are intended to be displayed in a document. The data receiving module 18 is connected to a template selection tool 20 which in turn is connected to the template storage unit 14. The template selection tool 20 is arranged to receive data from the data receiving module 18 and to search through the templates stored in the template storage unit 14 in order to select the most appropriate template for the data that are input.

A sorting module 19 is provided in between the template selection tool 20 and the template storage unit 14. The template selection tool 20 is arranged to assign a score to each template in the template storage unit 14 and the sorting module 19 arranges the templates in order of their score. In this way, the most appropriate template may be arranged at the top of a sorted list of templates.

As an alternative to a sorting module 19, a filtering module could be provided. In this arrangement the filtering module, upon instruction from the template selection tool 20, is arranged to exclude any inappropriate templates in the template storage unit 14 from consideration.

The template selection tool 20 comprises a direct connection to a document building module 24 which in turn is connected to the template storage unit 14. The document building module 24 receives the details of the selected template from the template selection tool 20, retrieves the template from the template storage unit 14, and builds a document by fitting the input data to the selected template.

The document building module 24 is present in a preferred embodiment of the invention. However, it may be absent in which case the automatic document generator 2 may be an automatic document selector 2 which is arranged to select the most appropriate template. A document building module 24 may be present but remote from the automatic document selector 2.

A processing module 22 and a template creation module 26 are provided in an optional path between the template selection tool 20 and the document building module 24. These modules 22,26 are used when the selected template requires modification before a document is built. The processing module 22 requires access to the input data in its calculations and therefore a direct connection is provided between the processing module 22 and the data receiving module 18.

The document building module 24 comprises a connection to a temporary data storage unit 28 which is remote from the automatic document generator 2 and is accessible by a user 4 over the internet. A document that is created by the document building module 24 is transmitted to the temporary data storage unit 28 so that it can be reviewed and approved by a user 4.

The document building module 24 also comprises a connection to an external Content Management System (CMS) 30 and an optional connection to an external spooler 32. The CMS 30 is connected to the spooler 32, when present, and also has a connection with a publisher 10. The document building module 24 sends finished routed documents as electronic files such as PDF, EPS, or other, either directly to the CMS 30 or initially to the spooler 32 and then to the CMS 30. The spooler 32 is arranged to provide mechanisms for setting up file-based workflows using “watched folders” or hot directories. The spooler is also arranged to perform transformations on received data in order to present data to the CMS 30 in a predetermined form.

FIG. 3 is further diagram showing how the automatic document generator 2 connects to external components. FIG. 3 also includes a flow diagram 48 which shows a user's interaction with the automatic document generator 2.

At login step 50 the user logs into the system over the internet by providing login details and a password. The user then indicates which type of document they would like to create at document selection step 52. For example, the user may be creating a page of a newspaper, a website, or a trade magazine; this selection may be used to limit the number of potential templates that are used in the document generation process.

At data entry step 54, the user inputs the data that are to be displayed in the document, including, for example text and images. The user may input all of the data that are required to be input to a multi-page document. These data may be pre-grouped by page or else the automatic document generator 2 may assign data to different pages.

At channel selection step 56, the user may specify the form of output that is desired. For example, the user may specify whether a soft or hard copy should be produced, the resolution that is required, and the quality of paper that should be used.

At generation step 58, the user can send an instruction to the automatic document generator 2 for it to generate a document. The document produced by the automatic document generator 2 may be previewed by the user at document preview step 60. An optional final route step may be provided in which the user can instruct the automatic document generator 2 to publish the document in the manner specified at the channel selection step 56.

The InDesign Plugin 29 utilises program functions for interfacing between an external server (not shown) and the automatic document generator 2. The external server comprises software for generating documents which is accessible via the InDesign Plugin 29.

In order to appreciate the operation of the automatic document generator 2 of the present invention an example is now given of the properties of a document template. An example of a document template 100 is shown in FIG. 4. The template 100 comprises a title text box object 102, a main body text box object 104, a first image object 106 and corresponding caption text box object 108, a second image box object 110, and corresponding caption text box object 112, a graphical object 114 which is a separator between the main text box object 104 and the image box objects 106, 110, and a logo object 116 which comprises a predetermined logo. All of the objects in the template apart from the graphical object 114 and logo object 116 are designed to accept input data from a user.

The properties of the objects in the template 100 are outlined in the table depicted in FIG. 5. The properties of the objects that are specified are: size, text capacity (where relevant), rule applied (where relevant), style (where relevant), and priority.

The size of each object is defined by its horizontal and vertical dimensions. Also, text objects have a text capacity which corresponds to the number of characters of text that can be received in the text object in a standard font and at a standard point size. For objects that can receive input data, rules can specify the properties that input data must possess if they are to be successfully received in the object. It is convenient in many circumstances that rules are defined by an object “style”. A style can be attributed to an object in order to automatically specify the relevant rules that should apply. It may be most convenient to have different styles for text than for other types of data such as image data, as different considerations apply. The priority of objects in the template relates to their relative importance in terms of fitting input data. Thus, it may be more important that the input data fit high priority objects than low priority objects.

Thus, considering FIG. 5, the title text box object 102 has a size of 12 cm×2 cm (horizontal×vertical) and has a text capacity of 50 characters. The rules for the input data specify that the input data must have 50 characters, plus or minus 10%. Therefore, the input data must have a number of characters that is in the range of 45 to 55 if it is to be accepted in the title text box object 102. If the number of characters input is 50 or less then the text may not require any modification in order to fit in the title text box object 102. However, if the number of characters is greater than 50 then the text or the text box object 102 requires modification if the text are to be displayed in full. Preferably the document building module 24 modifies the point size and/or font of the text in this regard.

The title text box object 102 has text style 1. Text style 1 is linked to the rule whereby the input data must have a number of characters which is plus or minus 10% of the text capacity of the text object. The first image caption text box 108 also has a text style 1. Thus, as the text capacity of this object is 80 characters, the object will accept text with a number of characters in the range of 72 to 88.

The image objects 106,110 also have associated rules and styles. For example, the first image object 106 has an associated rule specifying that an input image must have an area which is within 10% of the area of the first image object 106, if it is to be received therein. This rule is associated with image style 1. In another example, the second image object 110 has an associated rule specifying that the vertical dimensions of any input image must be within 5% of the vertical dimension of the second image object 110 (i.e. it must be in the range of 5.7 cm to 6.3 cm). This rule is associated with image style 2. It will be appreciated that any of a large number of rules may be applied to the input data that may be received in an image object. Also, any combination of different rules may be applied. For example, it would be possible to apply both image style 1 and image style 2 to an image object.

Rules are not applied to the graphical object 114 or the logo object 116 as input data cannot be received by these objects.

The main text box object 104 has priority 1 in the template, and none of the other objects have a priority associated with them. Thus, the main text box object 104 may be considered the dominant object in the template. Thus, when input data are fitted to the template it may be most relevant that the input data fit within the parameters specified by the main text box object rules.

FIG. 6 shows a flow diagram illustrating the operation of the automatic document generator 2 shown in FIG. 2. At input data step 64, a user submits data that they wish to have displayed in the document. These data are received by the data receiving module 18 and are made available to the template selection tool 20. The template selection tool 20 then undertakes a scoring procedure in order to determine a score for each template in the template storage unit 14.

The scoring procedure uses variables x and y which are initially set to 1 at initialisation step 66, but can take values of between 1 and xₘₐₓ and yₘₐₓ respectively. At score determination step 68, the template selection tool 20 determines a score for parameter x and template y from the template storage unit 14. Thus, the template selection tool 20 initially determines a score for the first parameter and the first template.

At comparison step 70 the value of y is compared to yₘₐₓ. If y is less than yₘₐₓ then y is incremented and the score determination step 68 determines the score for the first parameter and the second template.

At comparison step 72 the value of x is compared to xₘₐₓ. If x is less than xₘₐₓ then x is incremented so that a new parameter can be considered in the score determination step 68. The template selection tool 20 then re-runs the score determination step 68 in a loop to determine a score for each of the templates with respect to the new parameter.

The scoring procedure used in the score determination step 68 will now be described in greater detail. In the best mode of the invention there are eight parameters for which a score may be determined for a template; thus, Xmax is set to equal eight. The parameters are as follows, and are considered in the order presented:
1. Dominant input data within dominant object box rules?

According to the first parameter, a score is determined for a template by assessing whether the input data that correspond to the dominant object are within the dominant object box rules. This may result in a binary ‘pass’ or ‘fail’ score. Preferably a −1 score is indicative of a fail and a 0 score is indicative of a pass. Typically the dominant object in a template corresponds to main body text.
2. Image input data within image object box rules?

For parameter 2, a score is determined for any image input data. Ignoring any dominant object already considered, a ‘pass’ score of 0 is provided if the input image data fit within the corresponding image object box rules, and a ‘fail’ score of −1 is provided otherwise.
3. Text input data within text object box rules?

Similarly, ignoring any dominant object already considered, a ‘pass’ score of 0 is provided if the text input data fit within the corresponding text object box rules, and a ‘fail’ score of −1 is provided otherwise.
4. Any objects in the template that cannot be filled by input data? The number of objects in a template may be larger than the number of groups of input data. In these circumstances it is not possible to fill every object in the template with input data. Preferably a score of −1 is provided for each object in the template that cannot be filled.
5. Number of objects in the template that can be filled by input data?

Preferably a score of +1 is provided for each object in the template that can be filled by input data.
6. Goodness of fit of dominant object?

Preferably a floating point score is determined to assess the closeness of fit of the input data to the dominant object in the template. The dominant object is usually a main body text object so the scoring for this parameter shall be described in that context. A score of 0 is provided if the number of characters of input data precisely match the text capacity of the dominant text object. Otherwise a negative score is provided, the absolute value of which increases linearly where the number of characters of input data is less than the text capacity of the dominant object. The absolute value of the negative score increases exponentially where the number of characters of input data is greater than the text capacity of the dominant object. Thus, templates receive a better score when the number of characters would under-fill the dominant object than when they would over-fill it. This is preferable because an over-fill necessitates the modification of input data if they are to fit in the object.
7. Goodness of fit of area of image objects?

A floating point score of 0 is provided where the area of input images precisely matches that of the image objects in a template. Otherwise a negative score is provided. As with parameter 6 above, the absolute magnitude of the negative score increases linearly where the area of the images is less than the area of the corresponding image objects and increases exponentially where the area of the images is greater than the area of the corresponding image objects.
8. Goodness of fit with regards distortion of image objects?

The image input data may have different dimensions to corresponding image objects in the template. A score of 0 is provided if the dimensions of the input data precisely match those of the image objects. Otherwise a negative score is provided.

The score determination step 68 is able to determine a score for each of the templates in the template storage unit 14 according to each of the above eight parameters in sequence.

As the score determination step 68 may ascribe ‘fail’ scores of −1 to templates, it is possible that the number of candidate templates in the template storage unit 14 may reduce as each parameter is considered. At comparison step 71, an assessment is made as to whether there is only one candidate template remaining that has not received a fail score. If this is found to be the case the score determination process may be shortened as it is not necessary to continue to ascribe scores to the templates for each of the remaining parameters. Once the score determination process has been completed, the template selection tool 20 ranks the templates in numerical order at ranking step 74. The most appropriate template is preferably the template with the highest numerical score that is ranked at the top of the list of templates. The most appropriate template is selected by the template selection tool 20 at selection step 76.

Upon selection of an appropriate template a document is generated at building step 78 by the document building module 24. In this process, the input data are fitted to the corresponding object in the template.

In the building step 78 an assessment is made as to whether the input data would over-fill or under-fill the relevant object in the template.

Where the input data would over-fill the relevant object the input data need to be modified so that they fit the object correctly. The modification of data is controlled by building rules which are associated with each object in the template. Typically the building rules specify how the data are to be modified to fit inside the object. For example, for overset text it may be most appropriate to modify the data by decreasing the point size of the text. For overset images the data may be modified in a wide variety of different ways dependent on the circumstances; for example, it may be most appropriate to reduce the object such that it fits the object along its vertical dimension and then to crop the image, if necessary, along one side so that it fits the object.

Where the input data are underset it may not be necessary to modify the data as they would already fit inside the relevant object. However, it may be desirable to modify the data for aesthetic reasons such as to minimise the amount of white space in the template. For example, underset text data may be modified so that the point size is increased. Also, an underset image may be expanded in order to fit inside an image object.

In certain circumstances it may not be possible to build a document, even after an appropriate template has been selected by the template selection tool 76. For example, a text box object may specify an upper number of characters. However, a hidden proviso may be that the text can be fitted to a maximum number of lines in the object. If this text cannot be fitted to the maximum number of lines then the building step 78 may fail. In these circumstances the building step 78 feeds back to the template selection tool 76 so that the template selection tool can select the next most appropriate template in the ranked list. The feedback step may be undertaken as many times as is necessary, but in the event that the template selection tool exhausts appropriate templates from the ranked list, a default template is used in the building step. Default templates generally have very flexible data acceptance rules and data building rules so that a failure at the document building step 78 with a default template is unlikely.

Once a document has been built, filler objects may be added to the document at insert filler step 80. This may be relevant where an object in the template has not been filled by input data. For example, the template may comprise two image objects but the input data may only comprise one image. In these circumstances it may be appropriate to fill the empty image box with a pre-stored image, which may be an advertisement, or some other image.

Fillers may also be inserted in the white space left by underset data. For example, if the insertion of text in a text object leaves an area of white space it may be appropriate to fill that white space with a pre-stored object such as an advertising banner.

Finally, when a template has been filled with input data and optional fillers it is output at output step 82.

In another embodiment of the invention, templates may be stored in the template storage unit 14 in a flexible form whereby their precise final form is yet to be determined. This is achieved best with “paired templates”.

An example of a pair of templates 200, 300 is shown in FIG. 7 and their corresponding properties are shown in tabular form in FIG. 8. Each template comprises a title text box object 202,302, a main body text box object 204,304, a secondary text box object 206,306, a first image box object 208,308 with corresponding caption text box object 210,310, a second image box object 212,312 with corresponding caption text box object 214,314, and a graphical object 216,316 which is a column separator for visually separating the main body text from the images.

As can be seen from FIG. 8, the properties of the templates 200,300 vary because the sizes of the objects therein are different in certain instances. For example, the vertical extent of the main body text box object 204,304 is 15 cm in the first template 200 but 18 cm in the second template 300. It can also be noted that some of the objects are identical in the first template 200 and the second template: see for instance the title text box object 202,302.

Each object in each template has a predetermined position, shape and size. The configuration of each object may be designed by an administrator in order to achieve a desirable aesthetic effect.

The corresponding objects in the example templates 200,300 have identical data acceptance rules, styles and priorities in this example. However, this need not be the case and the two templates of a pair could differ in this respect.

The templates 200,300 comprise corresponding objects and are considered as a linked pair. The properties of data that are accepted by objects in the linked pair of templates are shown in FIG. 9. As can be seen, where there is a disparity in size between an object in the first template 200 and the second template 300, the range of input data that can be accepted is broader in the linked pair than in either of the templates individually. Where the objects are identical in the first template 200 and the second template 300 an identical range of input data can be accepted in the linked pair as could be accepted in either of the pair individually.

Considering FIG. 9 in detail, the title text box object 202,302 can accept 60 characters of text ±10% in the first template 200 and also 60 characters of text ±10% in the second template 300. Therefore, as shown in FIG. 9 the paired template title text box object can accept in the range of 54 to 66 characters of text. Taking another example, the second image box object 212,312 can accept input images with area 35 cm²±5% in the first template 200 and area 47.5 cm²±5% in the second template 300. Accordingly, the range of input data that can be accepted in the second image box object 212,312 in the paired template is in the range of 33.25 to 49.875 cm².

The details of paired templates can be stored in the template storage unit 14. The paired templates are then scored by the template selection tool 20 and, a paired template may be selected by the template selection tool 20 if it receives the highest score of any template in the template storage unit 14. Where a paired template is selected as the most appropriate template a new template is built using the paired template as a starting point. This is achieved with the processing module 22 and the template creation module 26 in the automatic document generator.

When a paired template is selected as the most appropriate template, it is selected as an appropriate starting point. A new template is built from the paired template using the processing module 22 and the template creation module 26.

The processing module 22 is arranged to determine a transformation value for the paired template. This is achieved by comparing a parameter of the input data to a parameter of the dominant object in the paired template. The transformation value from the first template towards the second template is determined according to equation 1.

$$T . V = \frac{\vert {A}_{1} - {A}_{data} \vert}{\vert {A}_{2} - {A}_{1} \vert} \qquad ( 1 )$$

In equation (1):

T.V —transformation value. Where T.V is constrained such that 0≦T.V≦1.
A₁—value of parameter A in dominant object of template 1
A₂—value of parameter A in dominant object of template 2
A_{data}—value of parameter A in input data

In the paired template example described with reference to FIGS. 8 to 10, the dominant object is the main text box object 204,304 because it has the highest priority. This object has a text capacity of 1000 characters in the first template 200 and a text capacity of 1200 characters in the second template 300. In one example, the input data comprises 1050 characters of text. Thus, according to equation (1) the transformation value (T.V)=0.25 (or 25%) in this example. By transforming the main text box object 204 by 25% from the first template to the second template, it enlarges from a text capacity of 1000 characters to a text capacity of 1050 characters. In this way, the object in the newly created template matches the input data.

All objects in the first template are transformed by the transformation value. The actual nature of the transformation depends on the relative dimensions of corresponding objects in the first and second templates 200,300. For example, the secondary text box 206,306 would contract in size when transformed from the first template 200 to the second template 300. A transformation value of 0.25 would result in the creation of a new secondary text box having a text capacity of 262.5 characters. This would typically be rounded up or down to an integer value.

In another example, the vertical dimension of the second image box 212,312 would expand in size from the first template 200 to the second template. A transformation value of 0.25 from the first template to the second would result in a new second image box having a vertical dimension of 7.625 cm; the horizontal dimension would remain unchanged at 5 cm.

In this way a new template can be created. The template is created such that the dominant object matches the size of input data corresponding to the dominant object. Other objects are transformed according to this transformation. Input data can then be fitted to the relevant objects by the document building module 24, as previously described.

Problems may arise in template creation with template pairs as certain transformation values could lead to unusable templates. An example of a template pair 400,500 that could lead to such a problem is shown in FIG. 10. The template pair comprises corresponding objects which are: a title text box object 402,502, a main body text box object 404,504, a secondary text box object 406,506, an image box object 408,508, and a graphical object 410,510 which is a column separator for visually separating the main body text from the image. The main body text box object 404,504 is dominant in the paired template.

FIG. 11 shows a newly created template 600 from the template pair which corresponds to a transformation value of approximately 0.5. As can be seen, the main text box object 604 and the graphical object 610 are partially overlaid on the secondary text box object 606. This may be undesirable as it may obscure data that are displayed in the template.

Preferably the template creation module 26 uses transformation rules for controlling the creation of a new template. The transformation rules may over-ride a standard transformation in circumstances where the standard transformation would result in an undesirable template. This may be achieved by controlling the relative locations of objects in a new template. For example, the transformation rules may specify that objects maintain a fixed predetermined separation, a minimum separation or a maximum separation in the new template.

In one example the transformation rules specify a minimum separation of objects in a created template in order to prevent objects from overlapping. FIG. 12 shows a template created from the template pair of FIG. 10 with a transformation value of approximately 0.5. In this example, which should be compared with the template shown in FIG. 11, objects do not overlap because of the transformation rules. Of course, in alternative embodiments it may be desirable for objects to overlap.

1. A document template generator for creating a document template comprising:
a base template having a primary object for receiving data for display;
a data receiving module for receiving input data which are related to data for display in a template;
a processing module for comparing a parameter of the input data to a parameter of the primary object in the base template to determine a transformation value therebetween; and
a template creating module for creating a template by transforming objects in the base template, wherein the primary object is transformed by the transformation value.

2. A document template generator according to claim 1 wherein the primary object has a first predetermined form and a second predetermined form and wherein the template creation module is arranged to transform the primary object in the base template from its first form towards its second form.

3. A document template generator according to claim 2 wherein the base template has a plurality of objects each having corresponding first and second predetermined forms, and wherein the template creation module is arranged to transform all objects relatively from their first form towards their second form.

4. A document template generator according to claim 3 wherein the transformation value relates to the relative transformation that is required to transform the primary object from its first form towards its second form, and wherein the template creation module is arranged to transform all objects from the first form towards the second form by a factor equal to the transformation value.

5. A document template generator according to claim 1 wherein the base template is a paired template comprising a first template having a primary object in a first form and a second template having a corresponding primary object in a second form, wherein the template creation module is arranged to transform all objects in the first template towards the form of the corresponding objects in the second template.

6. A document template generator according to claim 1 wherein the primary object is a text box and the input data is related to text for display in the template.

7. A document template generator according to claim 1 wherein the template creation module is arranged to transform all objects in the base template according to transformation rules.

8. A document template generator according to claim 7 wherein the transformation rules control at least one of: the relative forms of objects in the created template, the relative positions of objects in the created template, and the shapes of objects in the created template.

9. A document template generator according to claim 2 wherein the transformation value (T.V) is calculated using the equation:
$$T . V = \frac{\vert {A}_{1} - {A}_{data} \vert}{\vert {A}_{2} - {A}_{1} \vert}$$
where A₁ is the value of a parameter of the primary object in its first form, and A₂ is the value of the parameter of the primary object in its second form, and A_{data} is the value of a parameter of the input data.

10. A template selector comprising:
a data receiving module for receiving input data which are intended for display in a document;
a template storage unit for storing data relating to a plurality of document templates;
a template selection tool for selecting an appropriate base template from the template storage unit by comparing at least one attribute of the input data to at least one attribute of each of the stored templates, the appropriate base template having a primary object for receiving data for display;
a processing module for comparing a parameter of the input data to a parameter of the primary object in the base template to determine a transformation value therebetween; and
a template creation module for creating a template by transforming objects in the base template, wherein the primary object is transformed by the transformation value.

11. A document generator comprising:
a template selector according to claim 10; and
a document building module for building a document by fitting the input data to the template created by the template creation module.

12. A method of creating a document template comprising the steps of:
providing a base template having a primary object for receiving data for display;
receiving input data related to data for display in a template;
comparing a parameter of the input data to a parameter of the primary object in the base template to determine a transformation value therebetween; and
creating a template by transforming all objects in the base template; wherein the primary object is transformed by the transformation value.
